(19) United States
(12) Patent Application Publication
(10) Pub. No.: US 2001/0046287 A1
(43) Pub. Date: Nov. 29, 2001

(54) Communication installation and method for setting up a connection

(75) Inventor: Juergen Hoefig, Dortmund (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 09/858,351

(22) Filed: May 15, 2001

(30) Foreign Application Priority Data
May 16, 2000 (DE) 10023868.8

(51) Int. Cl. H04M 3/42

(52) U.S. Cl. 379/210.01

(57) ABSTRACT

Entry of a specific telephone number on a remote communication terminal (KE-A) initializes setup of a connection between the remote communication terminal (KE-A) and the communication installation (PBX). The central control unit (CC) of the communication installation (PBX) recognizes the specific telephone number and then activates a callback module (M-RR) of the communication installation (PBX) and terminates setup of the connection. The central control unit (CC) then automatically initializes setup of a new connection between the communication installation (PBX) and the remote communication terminal (KE-A) by accessing the callback module (M-RR) (PBX).

### BACKGROUND OF THE INVENTION

1. Field of the Invention

The present invention relates to a method for setting up a connection—particularly within the context of ‘teleworking’—between a local and a central communication facility, and to an appropriately designed communication installation.

2. Description of the Related Art

Working conditions are being made increasingly flexible in terms of time and space so that the number of employees who do not perform their professional duties at their company workplace is constantly rising. “Das virtuelle Büro” [The Virtual Office], Telcom Report, issue 4, 1997, Siemens AG Berlin and Munich discloses that, in order to perform duties effectively outside the company, it is necessary, first, to have access to the local data resources of the company (also called ‘remote LAN’) and, second, to have access to the communication facilities afforded in the local communication network of the company (also called ‘remote PBX’), irrespective of the location of the employee. The facilities include the facilities which are provided in addition to those provided as standard in a communication network (e.g., an ISDN-oriented network), such as setting up a conference circuit or signaling receipt of a message.

One option for a home worker (“remote subscriber”) to access the local communication network of the company is to initialize setup of a connection to the company at the subscriber end. The costs arising in association with this connection are attributed to the remote subscriber, however, which means that, among other things, considerable costs arise for the remote subscriber, depending on the location. Alternatively, it is a known practice to set up a permanent connection paid for by the company between the remote subscriber and the local communication network. Such a permanent connection is an ineffective alternative solution, however, since the transmission capacity which is permanently provided by a permanent connection is generally fully utilized only temporarily, which means that costs arise unnecessarily for the company during intervals of time in which the transmission capacity is not being fully utilized.

In addition, the German laid-open specification DE 198 17 494 A1 discloses a method for setting up a connection within the context of teleworking in which a connection setup message is transmitted to an application-specific teleworking computer connected to a company-internal communication installation from a remote subscriber by dialing a specific teleworking telephone number. The teleworking computer forwards the connection setup message to a subscriber line module providing access for the teleworking computer to the communication installation. If the telephone number associated with the remote subscriber was also transmitted automatically in the connection setup message (for example, within the context of an ISDN connection—as part of the “calling party number” facility), the subscriber line module automatically terminates setup of the connection and itself initializes setup of a connection to the remote subscriber using the telephone number which was also transmitted. This means that no costs arise for the remote subscriber for the connection which is to be set up.

A disadvantage of the principle described is that additional hardware components—a teleworking computer and a subscriber line module—are required for the communication installation in order to implement this method, which means that implementation of this method described in already existing systems requires a high level of complexity both in terms of design and in terms of control technology.

### SUMMARY OF THE INVENTION

The present invention is therefore based on the object of providing measures which can reduce the level of complexity for implementing such a method.

The object is achieved, by a method for setting up a connection between a local communication facility and a central communication facility, comprising the steps of: entering a specific telephone number on the local communication facility; initializing, by the local communications facility in response to the step of entering a specific telephone number, a setup of a connection between the local communication facility and the central communication facility; activating, by a central control unit of the central communication facility, a callback module of the central communication facility; terminating the setup of the connection; and automatically initializing a setup, by the central control unit, of a new connection between the central communication facility and the local communication facility by accessing the callback module. This method may further comprise the step of identifying a subscriber using the local communication facility before the callback module is activated. The subscriber may be identified using a subscriber-specific codeword and a facility-internal telephone number associated with the subscriber in the central communication facility. A step may be provided of terminating the setup of the connection between the local communication facility and the central communication facility only after entry of a specific key combination on the local communication facility. The new connection may be set up using a telephone number which is automatically transmitted from the local communication facility to the central communication facility as part of the connection setup. The new connection may be set up using a telephone number which is transmitted to the central communication facility together with the specific key combination. The new connection may be set up using a telephone number which is stored in a database of the central communication facility. The inventive method may also further comprise the steps of: starting a timer in the central communication facility when the setup of the connection has been terminated; and initializing the setup of the new connection only when the timer has run out.

The object is also achieved by a communication installation, comprising: access units for connecting communication terminals and communication networks to the communication installation; and a central control unit for controlling functions of the communication installation, comprising a callback module and a database; the central control unit being designed such that it terminates a setup, initialized by an entry of a specific telephone number on a remote communication terminal, of a connection between the remote communication terminal and the communication installation by accessing the callback module and the database and automatically initializing a setup of a new connection by the communication installation.

A fundamental advantage of the method according to the invention and of the communication installation according to the invention is that no additional hardware components are required for implementing the method, since the functional units required for providing the functions are integrated directly in the central control unit of the communication installation. This additionally reduces the volume of signaling within the communication installation, since signaling transmission between the central control unit and the hardware components—teleworking computer and subscriber line module—in accordance with the prior art can be dispensed with.

One advantage of embodiments of the invention which are described above is, amongst other things, that transmitting a combination comprising a communication-installation-internal telephone number associated with the subscriber and a subscriber-specific PIN (Personal Identification Number) allows unique identification of the remote subscriber initiating setup of the connection using data which are already present in the communication installation, and thus makes it a simple matter to prevent unauthorized access to data and services which are internal to the communication installation.

Another advantage of embodiments of the invention which are defined in the dependent claims is that the desired callback function is initiated by a particular function-specific key combination, which means that the method can easily be expanded for other functions by defining new function-specific key combinations.

### BRIEF DESCRIPTION OF THE DRAWINGS

An illustrative embodiment of the invention is explained in more detail below with the aid of the drawings.

FIG. 1 is a structural block diagram schematically illustrating the fundamental functional units of a communication installation according to the invention; and

FIG. 2 is a flowchart illustrating the fundamental method steps taking place in the method according to the invention.

### DETAILED DESCRIPTION OF THE INVENTION

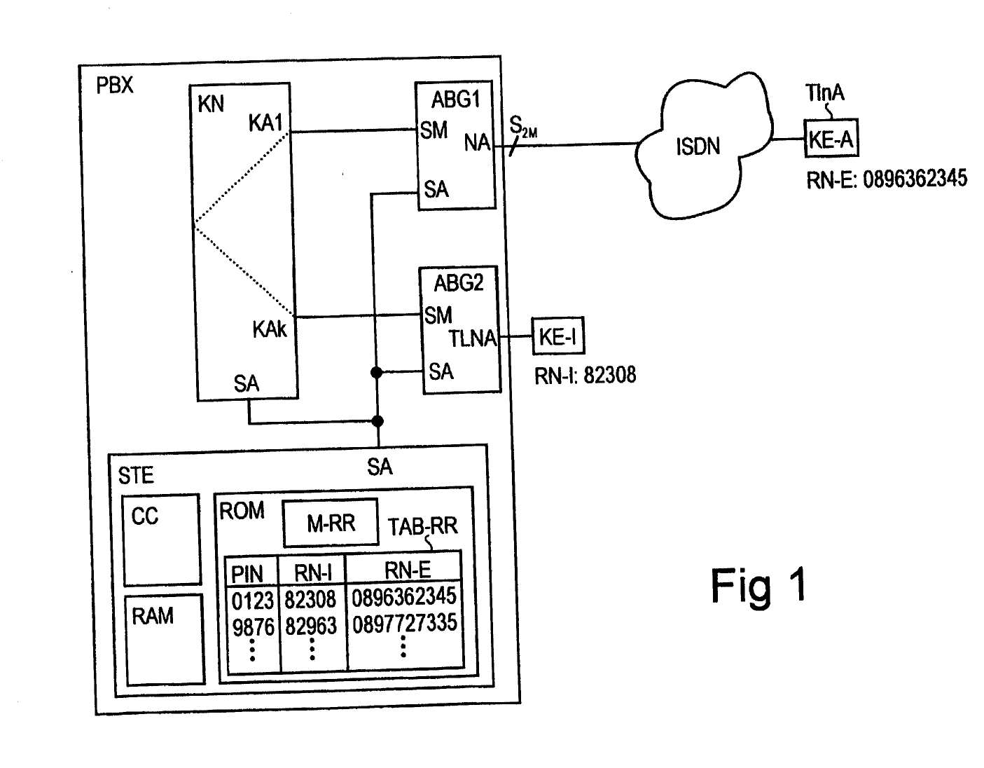

FIG. 1 shows a structural block diagram having the fundamental functional units of the communication installation PBX according to the invention. The communication installation PBX has subscriber line units and network interface units—by way of example, a first and a second access unit ABG1, ABG2 are shown—for connecting communication terminals or networks to the communication installation PBX. In addition, the communication installation PBX contains a switching matrix module KN having a plurality of bidirectional, time-division multiplex oriented switching connections KA1, . . . , KAk, the time-division multiplex oriented switching connections KA1, . . . , KAk possibly being in the form of PCM (Pulse Code Modulation) connections—also called PCM highways, speech highways, or S_{2M} connections. Each PCM highway generally comprises, first, 30 useful channels which are each in the form of ISDN (Integrated Services Digital Network) oriented B channels having a transmission rate of 64 kbit/s, and, second, a signaling channel which is in the form of an ISDN oriented D channel having a transmission rate of 64 kbit/s. The PCM connections KA1, . . . , KAk connect the switching matrix module KN to a respective bidirectional, time-division multiplex oriented connection SM of the first and second access units ABG1, ABG2.

In addition, the communication installation PBX contains a control unit STE controlling the functions of the communication installation PBX. To this end, the central control unit has a central processor CC and memory units RAM, ROM. In this context, a nonvolatile memory ROM is used for storing program modules which can be executed by the central processor CC, thus controlling the functions of the communication installation PBX. By way of example, a callback module M-RR is shown. By accessing this callback module M-RR, the central processor CC controls the functions which are to be provided within the context of the method according to the invention. The nonvolatile memory ROM is also used for storing data which are internal to the communication installation. By way of example, a table TAB-RR associated with the callback module M-RR is shown which is used for storing subscriber data required for the callback function. In this case, the subscriber data comprise a subscriber-specific PIN, a communication-installation-internal telephone number RN-I which is associated with the subscriber, and a communication-installation-external telephone number RN-E on which the subscriber can generally be reached outside of the company. If the subscriber TInA has no associated internal communication terminal KE-I connected to the communication installation PBX, it is alternatively possible for the communication-installation-internal telephone number RN-I for a fictitious connection port—i.e., for a purely logically existent connection port which is set up merely for administrative purposes and has no hardware components—to be transmitted to the communication installation PBX. This means that subscribers who have no internal subscriber line are also able to access data and services which are internal to the communication installation. A volatile memory unit RAM is used, among other things, for storing temporary data which need to be buffer-stored when a-program module (for example, the callback module M-RR) is executed.

A control connection SA connects the control unit STE to a control input SA of the switching matrix module KN and to control connections SA of the first and second access units ABG1, ABG2. In this context, control information is transmitted between the functional units on the basis of the HDLC (High Level Data Link Control) protocol, for example.

An ISDN oriented communication network ISDN is connected to a network connection NA—for example, a bidirectional, time-division multiplex oriented S_{2M} connection—of the first access unit ABG1. By way of example, a remote communication terminal KE-A is connected to the ISDN oriented communication network ISDN. In this case, the remote communication terminal KE-A has the associated external telephone number RN-E=0896362345 in the ISDN communication network. In addition, by way of example, an internal communication terminal KE-I is connected to a subscriber line TInA of the second access unit ABG2 of the communication installation PBX. In this case, the internal communication terminal KE-I has the associated communication-installation-internal telephone number RN-I=82308.

Connection of the remote communication terminal KE-A to the ISDN oriented communication network ISDN and of the internal communication terminal KE-I to the communication installation PBX is usually by way of S0 interfaces, or using interfaces which are derived from this, such as UP0 interfaces. In general, a UP0 interface and an S0 interface firstly comprise 2 useful data channels which are in the form of ISDN oriented B channels having a transmission bit rate of 64 kbit/s each, and secondly comprise a signaling channel which is in the form of an ISDN oriented D channel having a transmission bit rate of 16 kbit/s.

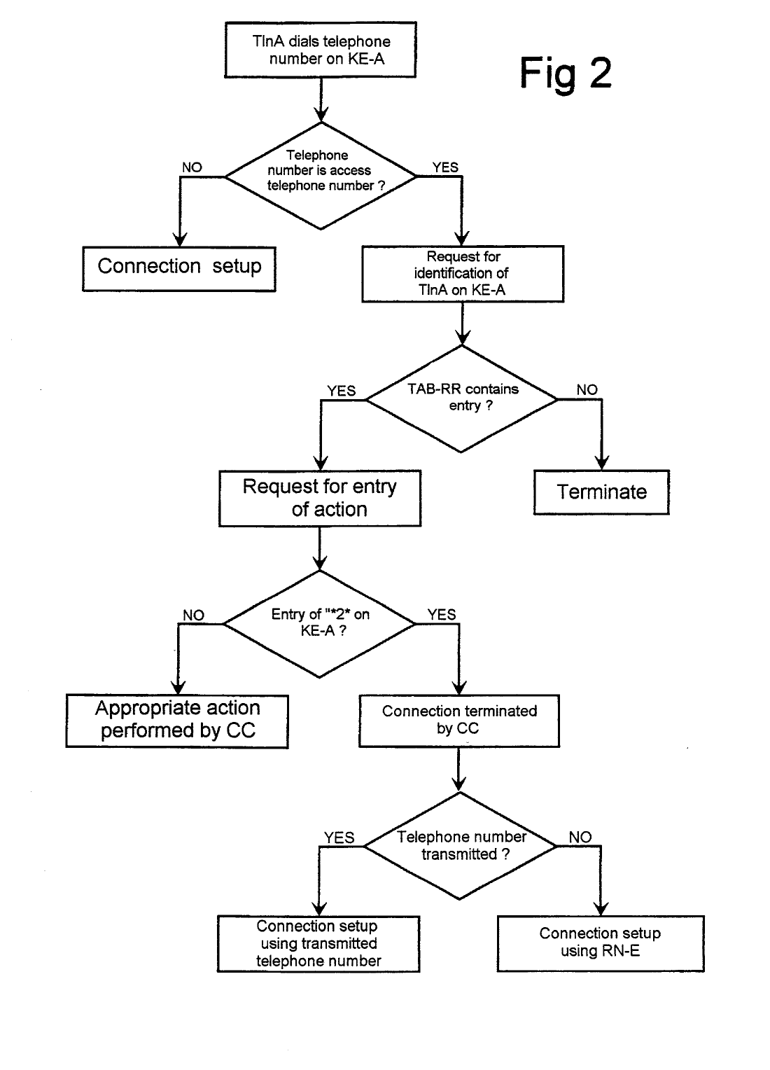

FIG. 2 shows a flowchart to illustrate the fundamental method steps taking place in the method according to the invention. If a setup of a connection to the communication installation PBX is initialized in a first step by entering a telephone number on the remote communication terminal KE-A, the central control unit STE of the communication installation PBX checks whether the entered telephone number is a specific access telephone number for the communication installation PBX. If this is not the case, a connection to a communication terminal identified by the telephone number is set up in the conventional manner.

If, on the other hand, the telephone number entered on the remote communication terminal KE-A corresponds to the specific access telephone number for the communication installation PBX, the central control unit STE transmits, to the remote communication terminal KE-A, a request for identification of the subscriber TInA who is using the remote communication terminal KE-A. In this context, the request for identification can be made by way of a voice message transmitted to the remote communication terminal KE-A from the communication installation PBX, or alternatively by transmitting a display text to be shown on a display of the remote communication terminal KE-A.

In the present illustrative embodiment, the subscriber TInA is identified by transmitting a combination comprising the communication-installation-internal telephone number RN-I associated with the subscriber and the subscriber-specific PIN. If the subscriber TInA is usually allocated the internal communication terminal KE-I in the company, the subscriber TInA would transmit the combination 823080123 for identification purposes. Information can be transmitted from the remote communication terminal KE-A in the form of DTMF (Dual Tone Multi Frequency) signals, for example. For the DTMF signals, each key on a terminal is allocated a characteristic signal which is transmitted to the communication installation PBX via the ISDN communication network ISDN when the key is pressed. The frequency and signal duration of a DTMF signal differ from those of the data which usually need to be transmitted via a voice link, which means that the DTMF signals can be identified and evaluated by the central control unit STE. Alternatively, information can also be transmitted from the remote communication terminal KE-A to the communication installation PBX in the form of digital control information (“keypads”) transmitted in the signaling channel (D channel) of the ISDN connection.

If the subscriber TInA has no associated internal communication terminal KE-I connected to the communication installation PBX, then the communication-installation-internal telephone number RN-I for a fictitious connection port—i.e., for a purely logically existent connection port which is set up merely for administrative purposes and has no hardware components—may alternatively be transmitted to the communication installation PBX. This means that subscribers who have no internal subscriber line are also able to access data and services which are internal to the communication installation.

In a next step, the combination entered on the remote communication terminal KE-A by the subscriber TInA is compared in the communication installation PBX with the subscriber-related entries in the table TAB-RR. If the table TAB-RR contains no entry corresponding to the transmitted combination, the procedure which has been started is terminated. If, on the other hand, the table TAB-RR does contain an entry corresponding to the transmitted combination, the subscriber TInA is identified as being authorized in the communication installation PBX by the central control unit STE. The central control unit STE then transmits to the remote communication terminal KE-A a request for entry of a function-specific key combination which initiates a function in the communication installation PBX. In the present illustrative embodiment, the callback function according to the invention has the function-specific key combination *2 associated with it. The request may, in turn, be made using an appropriate voice message or an appropriate display text.

If no key combination is entered on the remote communication terminal KE-A within a prescribed time interval, the procedure which has been started is terminated. If, however, a key combination—for example, transmitted by way of DTMF tones or keypads—is received at the communication installation PBX within the prescribed time interval, the central control unit STE performs the function corresponding to the key combination received. If the subscriber TInA has entered the key combination *2, identifying the callback function, on the remote communication terminal KE-A, the central control unit STE clears the connection existing between the remote communication terminal KE-A and the communication installation PBX. No costs at all or only low costs arise for the subscriber TInA, depending on the type of connection—a useful data connection via the B channel or a signaling connection via the D channel of an ISDN connection—which has been set up between the remote communication terminal KE-A and the communication installation PBX up to this instant.

In a next step, the central control unit STE checks whether the communication-installation-external telephone number RN-E associated with the remote communication terminal KE-A has been transmitted to the communication installation PBX as part of the procedure up to this point. Within the context of the “calling party number” facility, for example, the communication-installation-external telephone number RN-E may have been transmitted from the remote communication terminal KE-A to the communication installation PBX automatically as part of connection setup. Alternatively, the communication-installation-external telephone number RN-E may have been transmitted manually to the communication installation PBX by the subscriber TInA together with the key combination *2. A communication-installation-external telephone number RN-E received in this manner is buffer-stored in the volatile memory device RAM and is read out by the central processor CC for the setup of a subsequent connection. If a communication-installation-external telephone number RN-E has been transmitted to the communication installation PBX, the central control unit STE initializes setup of a new connection to the remote communication terminal KE-A using this transmitted communication-installation external telephone number RN-E.

If, on the other hand, no communication-installation-external telephone number RN-E has been transmitted to the central control unit STE, it is assumed that the subscriber TInA is at the communication terminal which has been preset as standard for him, and the central control unit STE initializes the setup of a new connection using the communication-installation-external telephone number RN-E which is stored in the table TAB-RR and is associated with the transmitted combination—comprising the communication-installation-internal telephone number RN-I and the PIN.

When the connection has been cleared by the central control unit STE, a timer is started, and initialization of the new connection setup is started only when this timer has run out. This ensures that the subscriber can also initiate the connection from the remote communication terminal KE-A when the connection has been automatically cleared by the central control unit STE. The timer thus prevents a new connection which is being set up from being rejected by the remote communication terminal KE-A because the subscriber TInA was not able to initiate the connection in adequate time, i.e., was not able to hang up in adequate time, for example.

Initialization of connection setup from the communication installation PBX means that no further costs are attributed to the subscriber TInA for a connection subsequently set up between the remote communication terminal KE-A and another communication terminal.

The above-described method and communications installation are illustrative of the principles of the present invention. Numerous modifications and adaptations will be readily apparent to those skilled in this art without departing from the spirit and scope of the present invention.

What is claimed is:

1. A method for setting up a connection between a local communication facility and a central communication facility, comprising the steps of:
entering a specific telephone number on said local communication facility;
initializing, by said local communications facility in response to said step of entering a specific telephone number, a setup of a connection between said local communication facility and said central communication facility;
activating, by a central control unit of said central communication facility, a callback module of said central communication facility;
terminating said setup of said connection; and
automatically initializing a setup, by said central control unit, of a new connection between said central communication facility and said local communication facility by accessing said callback module.

2. The method as claimed in claim 1, further comprising the step of identifying a subscriber using said local communication facility before said callback module is activated.

3. The method as claimed in claim 2, wherein said subscriber is identified using a subscriber-specific codeword and a facility-internal telephone number associated with said subscriber in said central communication facility.

4. The method as claimed in claim 1, further comprising the step of terminating said setup of said connection between said local communication facility and said central communication facility only after entry of a specific key combination on said local communication facility.

5. The method as claimed in claim 4, wherein said new connection is set up using a telephone number which is automatically transmitted from said local communication facility to said central communication facility as part of said connection setup.

6. The method as claimed in claim 4, wherein said new connection is set up using a telephone number which is transmitted to said central communication facility together with said specific key combination.

7. The method as claimed in claim 4, wherein said new connection is set up using a telephone number which is stored in a database of said central communication facility.

8. The method as claimed in claim 1, further comprising the steps of:
starting a timer in said central communication facility when said setup of said connection has been terminated; and
initializing said setup of said new connection only when said timer has run out.

9. A communication installation, comprising:
access units for connecting communication terminals and communication networks to said communication installation; and
a central control unit for controlling functions of said communication installation, comprising a callback module and a database;
said central control unit being designed such that it terminates a setup, initialized by an entry of a specific telephone number on a remote communication terminal, of a connection between said remote communication terminal and said communication installation by accessing said callback module and said database and automatically initializing a setup of a new connection by said communication installation.
